(19) United States
(12) Patent Application Publication
(10) Pub. No.: US 2020/0124177 A1
(43) Pub. Date: Apr. 23, 2020

(54) METHOD OF COATING A SHAFT SEAL FOR USE WITH ROTATING PARTS

(71) Applicant: Harry Arnon, Sanford, FL (US)

(72) Inventor: Harry Arnon, Sanford, FL (US)

(21) Appl. No.: 16/660,381

(22) Filed: Oct. 22, 2019

Related U.S. Application Data
(60) Provisional application No. 62/748,880, filed on Oct. 22, 2018.

(51) Int. Cl. F16J 15/16; B41J 11/00

(52) U.S. Cl. CPC F16J 15/164; B41J 11/002

(57) ABSTRACT

A method of coating a shaft seal for use with rotating parts is disclosed. The method includes providing a shaft seal having an annular shell and an inner lip concentrically spaced inward from an outer surface of the annular shell. The method also includes providing an ultraviolet (UV) coating, printing the UV coating to the outer surface of the annular shell, and exposing the UV coating on the outer surface of the annular shell to UV and other radiation. In addition, the method may include installing the shaft seal around a shaft.

### CROSS-REFERENCE TO RELATED APPLICATION

This application claims the benefit of U.S. Provisional Patent Application Ser. No. 62/748,880, filed on Oct. 22, 2018, the contents of which are herein incorporated by reference in their entirety.

### FIELD OF THE INVENTION

The present invention relates to seals, and more particularly, to a method of coating a shaft seal for use with rotating parts.

### BACKGROUND OF THE INVENTION

Shaft seals are used to prevent the escape of high temperature and high pressure fluid between a rotating shaft and a stationary housing. The shaft seal maintains an efficient sealing relationship between the rotating shaft and the stationary housing. The satisfactory operation of shaft seals to prevent the escape of fluid between the rotating shaft and the stationary housing is subject to increasing requirements for operation in a high temperature environment coupled with high fluid operating pressures. All of the elements of these shaft seals must be constructed of materials that are highly resistant to corrosion when operating in conjunction with a wide variety of volatile fluids. In addition, the shaft seals are required to be so constructed that the sealing surface of the non-rotating sealing element will remain in constant complete circumferential engagement with the rotating shaft under high axial loads.

While existing shaft seals have been developed to address the sealing surface around the rotating shaft, the sealing of the exterior surface of the shaft seal to the stationary housing has been problematic under high temperature and pressure conditions. In particular, current methods of applying suitable coatings generate excessive waste of the coating material. In addition to the additional expense generated by the waste, the coating material is hazardous and complex and costly arrangements are needed to safely manage the excess material. Accordingly, there is a need in the art for an improved method of coating the exterior surface of the stationary housing of the shaft seal.

### SUMMARY OF THE INVENTION

A method of coating a shaft seal for use with rotating automotive parts is disclosed. The method includes providing a shaft seal having an annular shell and an inner lip concentrically spaced inward from an outer surface of the annular shell. The method also includes providing an ultraviolet (UV) coating, printing the UV coating to the outer surface of the annular shell, and exposing the UV coating on the outer surface of the annular shell to UV or other forms of radiation. In addition, the method may include installing the shaft seal around a shaft.

In view of the foregoing, it is an object of the present invention to provide an improved shaft seal using printed UV coatings. These and other objects, aspects and advantages of the present invention will be better appreciated in view of the drawings and following detailed description of preferred embodiments.

### BRIEF DESCRIPTION OF DRAWINGS

FIG. 1 is a plan view of a typical shaft seal;

FIG. 2 is a perspective view of the shaft seal of FIG. 1;

FIG. 3 is a schematic view of an apparatus for printing an ultraviolet (UV) coating to an exterior surface of the shaft seal in accordance with the invention;

FIG. 4 is a schematic view of an apparatus for curing the printed UV coating of FIG. 4; and

FIG. 5 is a fragmentary sectional view showing the shaft seal in accordance with the invention installed on a shaft.

### DETAILED DESCRIPTION OF PREFERRED EMBODIMENTS

In the summary of the invention, provided above, and in the descriptions of certain preferred embodiments of the invention, reference is made to particular features of the invention, for example, method steps. It is to be understood that the disclosure of the invention in this specification includes all possible combinations of such particular features, regardless of whether a combination is explicitly described. For instance, where a particular feature is disclosed in the context of a particular aspect or embodiment of the invention, that feature can also be used, to the extent possible, in combination with and/or in the context of other particular aspects and embodiments of the invention, and in the invention generally.

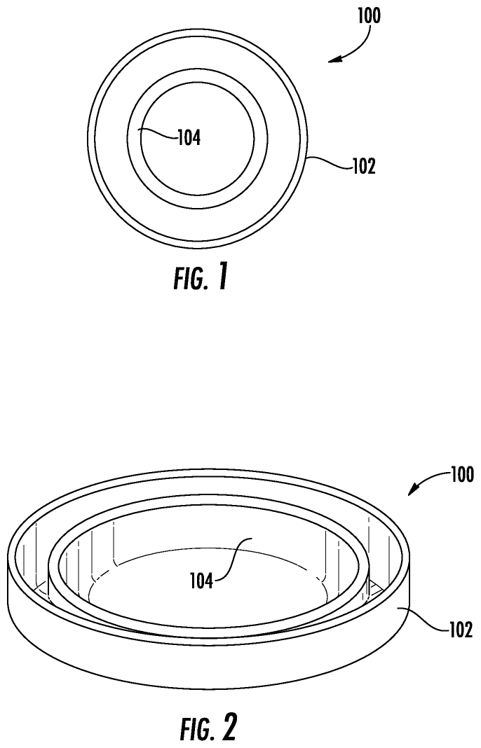

Referring now to FIGS. 1 and 2, a typical shaft seal 100 is illustrated that includes an annular shell 102 having a concentrically positioned inner lip 104. FIG. 1 is a plan view of the shaft seal 100 and FIG. 2 is a perspective view of the shaft seal 100.

A schematic view of a coating device 115 for applying a UV coating 110 to the exterior surface of the annular shell 102 in accordance with an aspect of the invention is illustrated in FIG. 3. In particular, a UV printer 114 is in communication with a reservoir 118 having the UV coating 110 stored therein.

The UV printer 114 includes a print head 116 positioned proximate to the exterior surface of the annular shell 102 and is configured to print the UV coating 110 to the exterior surface of the annular shell 102 to fabricate a coated shaft seal 100A. An axle 119 is configured to grip and rotate the shaft seal 100A as the print head 116 prints the UV coating 110 to the exterior surface of the annular shell 102 as the shaft seal 100A rotates beneath it.

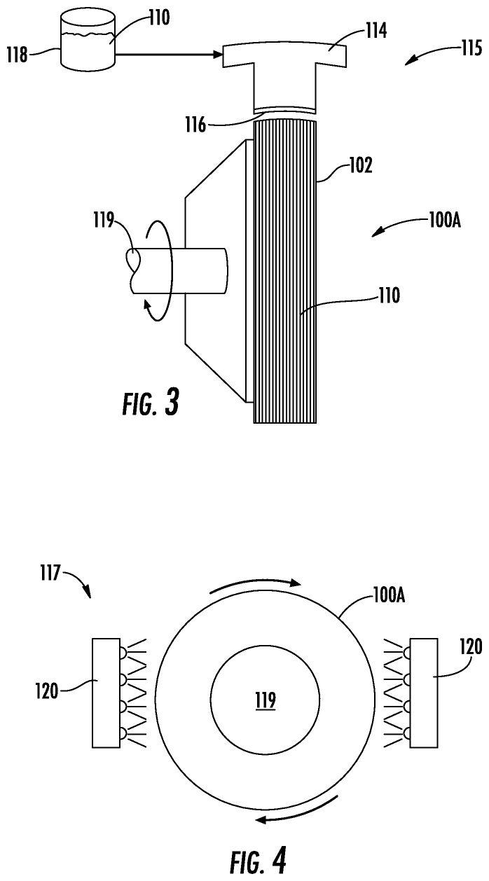

Referring to FIG. 4, a curing device 117 includes at least one UV curing light 120 configured to cure the UV coating 110 applied to the exterior surface of the annular shell 102. As the axle 119 rotates the coated shaft seal 110A, the UV curing lights 120 having an array of UV LED lights cures the UV coating. At the desired wavelength and intensity, the UV exposure needed is only a few seconds to cure the UV coating 110 to the exterior surface of the annular shell 102.

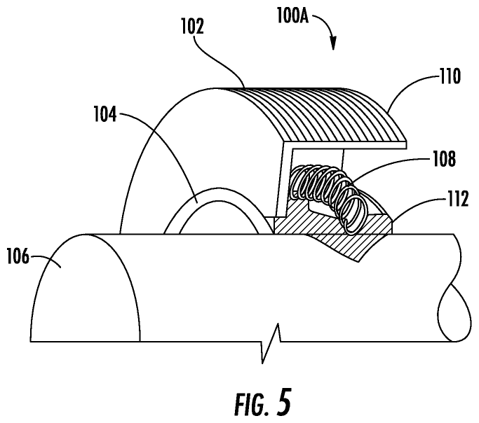

Referring now to FIG. 5, which is a partial cross sectional view of the coated shaft seal 100A installed around a shaft 106, a rubber or synthetic rubber sealing element 112 may be inserted about the inner lip 104 of the shaft seal. In addition, a garter spring 108 or like biasing element may be placed around the sealing element 112 to further effectuate a fluid tight seal between the sealing element 112 and the shaft 106. Further, the cured UV coating 110 on the exterior surface of the annular shell 102 also forms a fluid tight seal between the exterior of the shaft seal 110A and the components.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described.

What is claimed is:

1. A method of making a shaft seal, the method comprising:
placing an exterior surface of an annular shell of the shaft seal adjacent to a print head;
printing a coating onto the exterior surface from the print head;
placing the coated exterior surface adjacent to at least one ultraviolet (UV) curing light; and
curing the coated exterior surface using the at least one UV curing light.

2. The method of claim 1, wherein placing the exterior surface of the annular shell of the shaft seal adjacent to a print head includes mounting the shaft seal on an axle, and printing the coating onto the exterior surface from the print head includes rotating the shaft seal using the axle while printing.

3. The method of claim 1, wherein placing the coated exterior surface adjacent to the at least one UV curing light includes placing the coated exterior surface adjacent to an array of a plurality of UV light emitting diodes (LEDs).

4. The method of claim 1, wherein placing the exterior surface of the annular shell of the shaft seal adjacent to the at least one UV curing light includes mounting the shaft seal on an axle, and curing the coated exterior surface using the at least one UV curing light includes rotating the shaft seal using the axle while printing.

5. The method of claim 1, further comprising inserting a sealing element about an inner lip of the shaft seal, the inner lip being concentrically positioned within the annular shell.

6. The method of claim 5, further comprising mounting the shaft seal onto a shaft such that the sealing element engages the shaft and the coated exterior surface faces away from the shaft.

7. The method of claim 6, further comprising arranging a biasing element around the sealing element to bias the sealing element into engagement with the shaft.

8. A method of making a shaft seal, the method comprising:
placing an annular shell of the shaft seal on an axle such that an exterior surface of the shaft seal faces away from the axle;
placing the exterior surface of the shaft axle adjacent a print head;
rotating the annular shell on the axle while printing a coating onto the exterior surface using the print head;
placing the coated exterior surface adjacent at least one ultraviolet (UV) curing light; and
rotating the annular shell on the axle while curing the coated exterior surface using the at least one UV curing light.

9. The method of claim 8, further comprising inserting a sealing element about an inner lip of the shaft seal, the inner lip being concentrically positioned within the annular shell.

10. The method of claim 9, further comprising mounting the shaft seal onto a shaft such that the sealing element engages the shaft and the coated exterior surface faces away from the shaft.

11. The method of claim 10, further comprising arranging a biasing element around the sealing element to bias the sealing element into engagement with the shaft.

12. A shaft seal comprising:
an annular shell having an exterior surface and a concentric inner lip; and
an ultraviolet (UV) cured coating printed onto the exterior surface.

13. The shaft seal of claim 12, further comprising a sealing element inserted about the inner lip and configured to engage a shaft passing therethrough.

14. The shaft seal of claim 13, further comprising a biasing element placed around the sealing element and configured to urge the sealing element into engagement with the shaft.
